(19) United States
(12) Patent Application Publication
(10) Pub. No.: US 2010/0155156 A1
(43) Pub. Date: Jun. 24, 2010

(54) ENERGETICALLY AUTONOMOUS TACTICAL ROBOT AND ASSOCIATED METHODOLOGY OF OPERATION

(75) Inventor: Robert Finkelstein, Potomac, MD (US)

Correspondence Address: OBLON, SPIVAK, MCCLELLAND MAIER & NEUSTADT, L.L.P., 1940 DUKE STREET, ALEXANDRIA, VA, 22314, US

(73) Assignee: Robotic Technology Inc., Potomac, MD (US)

(21) Appl. No.: 12/612,489

(22) Filed: Nov. 4, 2009

Related U.S. Application Data
(60) Provisional application No. 61/111,208, filed on Nov. 4, 2008.

(51) Int. Cl. G05B 19/00; G06F 19/00; B60K 8/00

(52) U.S. Cl. 180/54.1; 700/245; 700/258; 700/246; 901/1; 901/46

(57) ABSTRACT

A robotic apparatus is provided that forages for a suitable fuel and is guided by an autonomous control system. The robotic apparatus automatically decides to search for suitable fuel and execute activities required to locate the suitable fuel and distinguish the suitable fuel from unsuitable fuel. Once the suitable fuel is identified, the apparatus moves to the fuel via a platform. A robotic arm and end effector grasp and transport the suitable fuel to a power generator to convert the suitable fuel to energy to power the robotic apparatus.

### CROSS-REFERENCE TO RELATED APPLICATION

This application claims the benefit of priority under 35 U.S.C. §119(e) to U.S. Application No. 61/111,208, filed on Nov. 4, 2008, the entire contents of which are incorporated by reference herein.

### STATEMENT REGARDING FEDERALLY SPONSORED RESEARCH OR DEVELOPMENT

The U.S. Government has the right to use this invention for its own use, and other teaming partners including Elbit Systems of America (U.S. corporate headquarters located at 4700 Marine Creek Parkway, Fort Worth, Tex. 76179-6969) and Boeing Corp. (corporate offices located at 100 North Riverside, Chicago, Ill. 60606) also have the right to use this invention for their own use, as provided for by the terms of contract W31P4Q-08-C-0292 awarded by the Defense Advanced Research Projects Agency (DARPA).

### BACKGROUND

An energetically autonomous tactical robotic apparatus is provided that forages for fuel.

Robots have been used for long-endurance, tedious, and hazardous tasks, but their application has been limited by the need for the robotic platform to replenish its fuel supply, for example, by humans manually re-fueling them. To provide independence from manual re-fueling in remote areas, robots have had stored energy capability or solar power generation capability to operate independently from their human minders. The solar power generation is insufficient in many instances because of weather or the inadequate ability to generate a significant strength of power. Accordingly, the robots become inoperable once their stored power is fully consumed.

There have been many attempts to create improved power generation capability for a robotic apparatus to operate in remote environments away from people to manage the power supplied to the robot. Although foregoing efforts have met with varying degrees of success, there remains an unresolved need for providing power to a robotic apparatus in remote environments away from human minders.

### SUMMARY

The exemplary embodiments described herein address the above limitations of conventional robots that need to be resupplied with power by their human minders while operating in remote areas.

In an exemplary embodiment, a robotic apparatus comprises a platform to transport the robotic apparatus, a power generator to convert fuel to energy to provide power for the platform, manipulators to transfer the fuel from outside of the robotic apparatus to the power generator, and an autonomous control system to identify, locate, and acquire the fuel for the robotic apparatus by controlling the platform and the manipulators.

In another exemplary embodiment, a method for a control system to autonomously supply power to a robotic apparatus comprises identifying an energy source, locating an approximate spatial location of the energy source, moving the robotic apparatus to a vicinity of the energy source, extending a robotic arm and an end effector of the robotic apparatus to contact the energy source, grasping and manipulating the energy source with the end effector, transporting the energy source with the end effector and robotic arm to a power generator, converting, at the power generator, the energy sources to power for the robotic apparatus, and powering the robotic apparatus with the power converted by the power generator.

As should be apparent, the exemplary embodiments can provide a number of advantageous features and benefits. It is to be understood that an embodiment can be constructed to include one or more features or benefits of embodiments disclosed herein, without including others. Accordingly, it is to be understood that the preferred embodiments discussed herein are provided as examples and are not to be construed as limiting, particularly since embodiments can be formed that do not include each of the features of the disclosed examples.

### BRIEF DESCRIPTION OF THE DRAWINGS

The exemplary embodiments will be better understood from reading the description which follows and from examining the accompanying figures. These are provided solely as non-limiting examples of the embodiments. In the drawings:

FIG. 1 is a block diagram of an exemplary architecture of an exemplary embodiment of an energetically autonomous tactical robot;

FIG. 2 is an exemplary platform of the architecture of FIG. 1;

FIG. 3 is an exemplary spectral response of vegetation;

FIG. 4 is an exemplary robotic arm of the architecture of FIG. 1;

FIGS. 5a and 5b are an exemplary hybrid steam engine with biomass combustion chamber of FIG. 1.

FIG. 6 is an exemplary 4D/RCS node;

FIG. 7 is an example of the 4D/RCS hierarchy that is divided into FIGS. 7a-7d;

FIG. 8 is a flow chart of an exemplary classification algorithm performed by the robot of FIG. 1.

### DETAILED DESCRIPTION

Reference will now be made in detail to the exemplary embodiments illustrated in the accompanying drawings. Wherever possible, the same reference characters will be used throughout the drawings to refer to the same or like parts.

In an exemplary embodiment, an Energetically Autonomous Tactical Robot (EATR) is a robot provided to perform a variety of military and civil robotic missions and functions without the need for manual refueling; the EATR can be a robotic ground vehicle. The EATR is an integrated system with the ability to forage for its energy from fuel in the environment, with fuel sources such as biomass (especially vegetation) or combustible artifacts (especially paper or wood products). Thus, the EATR is able to find, ingest, and extract energy from biomass in the environment (and other organically-based energy sources), as well as use conventional and alternative fuels (such as gasoline, heavy fuel, kerosene, diesel, propane, coal, cooking oil, and solar) when suitable.

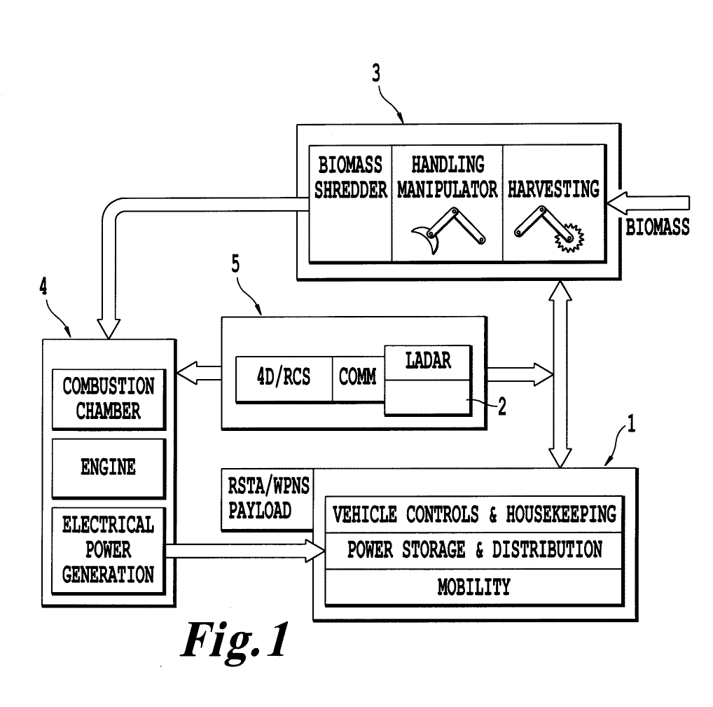

An EATR architecture is diagrammed in FIG. 1. As can be seen in FIG. 1, the EATR includes five subsystems: a platform 1; sensors 2; manipulators 3; an engine subsystem 4; and an autonomous control system 5.

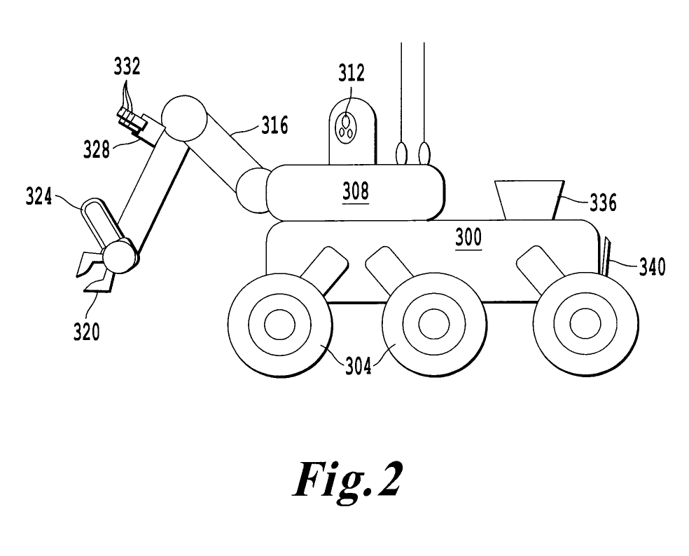

The platform 1 of the EATR can comprise any suitable configuration and be capable of operating in any medium: ground, air, or water, or a combination, such as amphibious. An exemplary platform 1 is shown in FIG. 2, but it may also be a robotically-modified vehicle, such as the High Mobility Multi-Wheeled Vehicle (HMMWV®) produced by AM General with headquarters at 105 N. Niles Ave., South Bend, Ind. 46634. The platform 1 provides mobility for the mission and mission payload assigned to the EATR.

Mobility can be accomplished by any suitable mechanism, including wheels, tracks, legs, or propellers. The platform 1 can be switchable between manned and unmanned (robotic), or solely robotic. It can be a modified conventional manned vehicle or a robotic vehicle. It can be humanoid or non-humanoid in appearance. For example, the rest of the EATR architecture can be integrated into the HMMWV® or mounted on a trailer attached to the vehicle.

The platform 1 shown in FIG. 2 includes a MULE chassis 300 having a plurality of wheels 304 attached thereto. The MULE chassis 300 also includes a turret 308 having sensors 2 positioned thereon such as cameras 312 (discussed below) to aid with reconnaissance, surveillance, and target acquisition. Manipulators 3, including an arm 316 having a gripper 320 and chain saw 324 at an end thereof, extend from the turret 308. Additional sensors 2, such as a SICK ladar 328 (discussed further below) and associated cameras 332 (for example, Foveal/Peripheral cameras and Stereo cameras), are positioned on the manipulators 3.

The MULE chassis 300 of the platform 1 can also include a bin for combustibles 336 in which fuel for the engine subsystem 4 is inserted. Additionally, the MULE chassis 300 can store PackBots therein to aid the EATR perform its missions. The MULE chassis 300 has a ramp 340 for the PackBots to enter and exit the platform 1.

The sensors 2 of the EATR are of a type and quantity needed for the robot to: (1) detect and identify suitable sources of energy in the environment outside of the EATR, especially biomass; (2) provide information to allow the robotic arm and effector to manipulate sources of energy; (3) accomplish its mission or function. The sensors 2 include active and passive optical sensors (e.g., ladar and video), in the visible and non-visible parts of the spectrum; radar; and acoustic. Exemplary sensors include: the Hokuyo ladar, manufactured by Hokuyo Automatic Company Ltd., Osaka HU Building, 2-2-5 Tokiwamachi, Chuo-Ku, Osaka, 540-0028 Japan; the X-10 Sentry Camera, manufactured by X-10.Com, 620 Naches St. SW, Renton, Wash. 98057; XCam2, manufactured by X-10.Com, 620 Naches St. SW, Renton, Wash. 98057; Ultrasonic Proximity Sensors, manufactured by FactoryMation, LLC, 156 Bluffs Conn., Canton, Ga. 30114; 24 GHz Narrowband Automotive Radar, manufactured by Smart Microwave Sensors GmbH, Mittelweg 7, D-38106 Braunschweig, Niedersachsen, Germany; and Automotive Infrared cameras, manufactured by Sierra Pacific Innovations Corp., 6620 S Tenaya Way, #100, Las Vegas, Nev. 89148.

In one exemplary embodiment, the sensors 2 provide omni-directional views, updated in real time with registered range and color information. It is possible to use only passive cameras for both range (stereo) and color information. Alternatively, the sensors 2 can include both active ladar (LAser Detection And Ranging) sensors and passive computer vision cameras, because ladar can directly measure range. The fields of view of the sensors 2 are usually limited, but the sensors 2 are controlled and pointed at areas of interest in accordance with instructions from the autonomous control system 5. Ladar sensors include line-scan units (such as the 3×SICK ladar or the LD-MRS SICK ladar manufactured by SICK AG based in Waldkirch, Germany) which emit a single plane of laser light, spanning 100°-180°, which can be mechanically scanned over a scene to build a range map.

Range can be found to all points that intersect with the line, based on the time-of-flight of the light pulses. The most advanced 3-D flash ladar sensors (such as those manufactured by Advanced Scientific Concepts Inc. of 135 East Ortega Street, Santa Barbara, Calif. 93101) can directly image a scene without scanning, giving range data as well as color in a single instant. Range resolution varies from a few millimeters to several centimeters, and measurable range varies from less than 10 m to more than 800 m, depending on the sensor used. Cameras for computer vision applications can deliver 1024×768 color images at 30 Hz, for example, the SwissRanger™ SR4000, manufactured by MESA Imaging AG, Technoparkstrasse 1, 8005 Zuerich. This provides ample resolution for object recognition or for stereo-based range computation.

With multiple sensors 2 mounted on a robot, the issue arises of how to integrate the sensors 2, including how to relate the information from each one to the others. This can require sensor registration in which the relative positions and fields of view of the sensors 2 are calibrated. The position and orientation of each sensor 2 is measured, and the sensors 2 are represented in a common coordinate system (usually that of the robot). The fields of view are then computed and overlaps are used for sensor fusion.

The sensing is coupled with the autonomous intelligent control system 5 (discussed further below) to provide perception and the ability to recognize and locate sources of energy. There are various techniques and systems for robots to perform sensing and perception, but the EATR can use a ladar as the primary sensor, especially to determine the position of suitable biomass relative to the position of the robotic end effector. While ladar technology is more than four decades old, ladar imaging is a major technology breakthrough of the past decade. For example, with data integration and fusion of ladar and stereo data it is possible to have near-optical quality with laser range image having a 5×80 degree field of view, 0.02 degree angular resolution, and 2 cm range resolution.

Ladar cameras produce images consisting of range pixels (picture elements) as opposed to (or in addition to) ordinary video images consisting of brightness or color pixels. Each pixel in the ladar image contains a measure of the distance from the camera to a region of space filled by a reflecting surface. When projected into a polar or Cartesian coordinate system, the result is a cloud of points in 3-D space that can be manipulated in many different ways and visualized from different perspectives. For example, a cloud of 3-D points can be viewed from the camera point of view or can be transformed into a planar map view in world coordinates for path planning. Alternatively, the cloud of 3-D points can be transformed into any number of other coordinate frames to simplify algorithms in computational geometry, segmentation, tracking, measurement, and object classification.

Ladar provides an improvement in image understanding capabilities over what can be accomplished by processing images from intensity or color properties alone. For example, a range-threshold or range-window can be applied to the ladar range image to segment an object (such as a tree) from the background (such as the forest), or to measure the slope of the ground, or detect objects that lie above the ground, or ditches that lie below the ground surface. In an intensity or color image, these types of segmentation problems can be difficult or impossible to solve. In a range image, they are quite straight forward.

In an intensity or color image, range to objects may be ambiguous. To infer range can be difficult and computationally intensive. Computation of range from stereo image-pairs or from image flow requires a great deal of computing power, and is not robust in natural environments that contain dense foliage. Many cues for range (such as occlusion, shape from shading, range from texture, and range from a priori knowledge of size) require high-level cognitive reasoning and are imprecise at best. In a ladar image, range is measured directly, robustly, and with great precision. Each pixel in a ladar image can be unambiguously transformed into a geometrical and dynamic model of the world that can support path-planning, problem-solving, and decision-making.

The ladar can be used to build a precise, unambiguous geometrical model of the world directly from the image, and track the motion of entities through the world. By meshing the 3-D points, it is possible to define surfaces and segment objects using only geometric methods that operate directly on the ladar image. Color, intensity, and (in the case of FLIR cameras) temperature of surfaces can be registered and overlaid on this geometrical model. The model can be then be segmented into geometrical entities consisting of points, edges, surfaces, boundaries, objects, and groups. Once segmentation is accomplished, entity state (i.e., position, velocity, and orientation) can be computed and used to track entities through space over time. Entity attributes (e.g., size, shape, color, texture, and behavior) can be computed and compared with attributes of class prototypes. Entities whose attributes match those of class prototypes are assigned class membership. Class membership then allows entities to inherit class attributes that are not computable from the image. This process can be embedded in a recursive estimation loop at many different levels of resolution.

While spinning minors can be used to scan a light beam to produce a ladar image, the focal plane arrays of detectors can also be used to produce a simultaneous range image. Thus, the ladar is a compact, light weight, low power, and potentially inexpensive solid state device.

In addition to the ladar, one or more optical, infrared, and microwave sensors 2 are used by the EATR to determine the optimum configuration and integrated sensor system for detecting, discerning, and locating biomass energy sources to provide fuel for the EATR.

Relevant biomass and biomass environmental characteristics that are sensed (in various wavelengths by various sensors) by an operational EATR might include: dimension, texture, and shape characteristics (e.g., distinguish among leaves, stems, flowers, stalks, and limbs of grass, plants, shrubs, and trees); spectral response (e.g., red, green, and blue differentials for chlorophyll pigments, and cells); reflectance properties (e.g., brightness, greenness, moisture); terrain characteristics (e.g., latitude, elevation above sea level, length of the growing season, soil type, drainage conditions, topographic aspect and slope, ground surface texture, roughness, and local slope properties); and climate conditions (e.g., solar radiation, temperature regime, prevailing winds, salt spray, air pollutants).

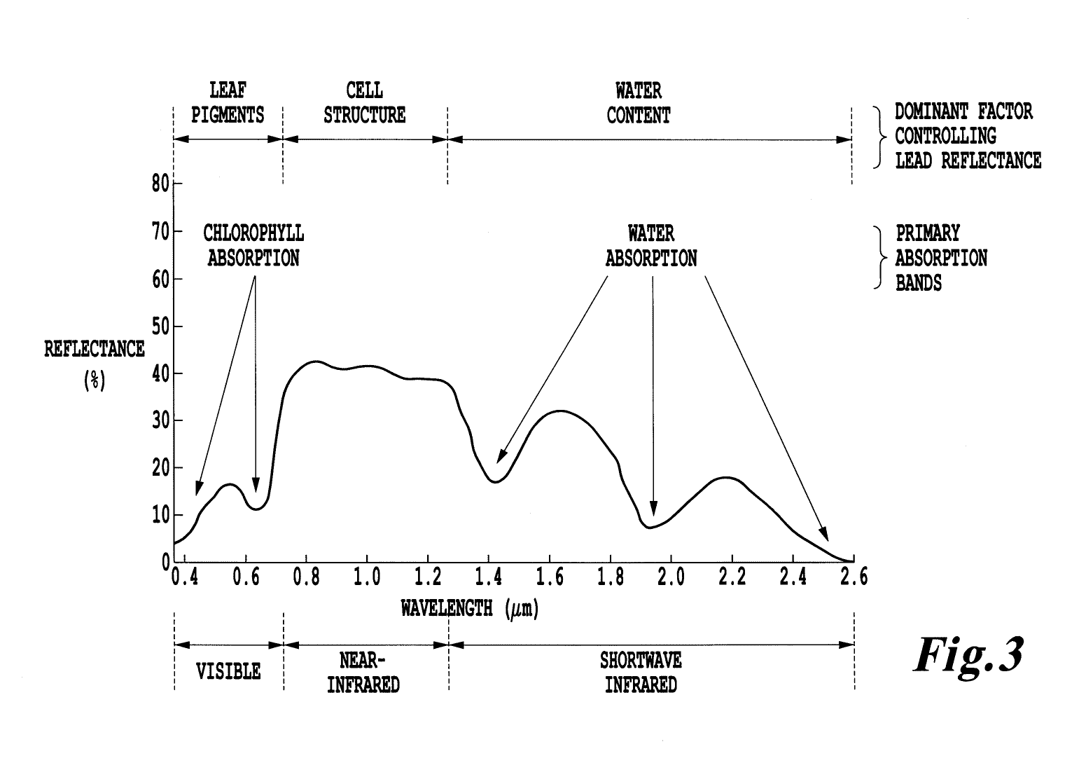

FIG. 3 illustrates example spectral response characteristics of green vegetation. As seen from FIG. 3, various parts of the electromagnetic spectrum are used to discriminate among different vegetation characteristics, including:

Wavelength 0.45-0.52 microns (blue): Soil/vegetation discrimination, forest mapping, culture feature identification (e.g., agricultural fields or gardens);

Wavelength 0.52-0.60 microns (green): Green reflectance peak for vegetation discrimination and vigor assessment, culture feature identification (e.g., agricultural fields or gardens);

Wavelength 0.63-0.69 microns (red): Chlorophyll absorption region for plant species discrimination, culture feature identification (e.g., agricultural fields or gardens);

Wavelength 0.76-0.90 microns (near infrared): Determining vegetation types, vigor, biomass content, soil moisture discrimination;

Wavelength 1.55-1.75 microns (mid-infrared): Vegetation moisture content; soil moisture discrimination; thermal mapping;

Wavelength 2.08-2.35 microns (mid-infrared): Vegetation moisture content; mineral and rock discrimination; and

Wavelength 10.4-12.5 microns (thermal infrared): Vegetation stress analysis; soil moisture discrimination; thermal mapping, where 1 micron=1 micrometer=1 millionth of a meter=10,000 angstroms.

Perception by the EATR begins with sensing and ends with a world model containing information that is suitable for the system to make decisions and plan and perform its mission or accomplish its intended function. In biological creatures, perception is a hierarchical process that begins with arrays of tactile sensors in the skin, arrays of photoreceptors in the eyes, arrays of acoustic sensors in the ears, arrays of inertial sensors in the vestibular apparatus, arrays of proprioceptive sensors (that measure position, velocity, and force) in the muscles and joints, and a variety of internal sensors that measure chemical composition of the blood, pressure in the circulatory system, and several other sensory modalities. Biological perception results in an awareness of the situation in the world and of the self in relation to the world (i.e., situational awareness).

In the modified 4D/RCS that is used by the autonomous control system 5 of the EATR, visual perception is a hierarchical process that begins with arrays of pixels in cameras, signals from inertial sensors and GPS receivers, and signals from actuator encoders. The process ends with a world model consisting of data structures that include a registered set of images and maps with labeled regions, or entities, that are linked to each other and to entity frames that contain entity attributes (e.g., size, shape, color, texture, temperature), state (e.g., position, orientation, velocity), class membership (e.g., trees, shrubs, grass, paper, wood, rocks, bricks, sand), plus a set of pointers that define relationships among and between entities and events (e.g., situations). These provide the autonomous vehicle with awareness of the world and of itself in relation to objects in the world.

Perception does not function by reducing a large amount of sensory data to a few symbolic variables that are then used to trigger appropriate behaviors. Instead, perception increases and enriches the sensory data by computing attributes and combining it with a priori information so that the world model contains much more information (not less) than what is contained in the sensory input. For example, only the intensity, color, and range of images may come directly from sensory input, but the decision space is enriched by segmenting the world into meaningful entities, events, and relationships, and then detecting patterns and recognizing situations which are bound to symbolic variables that trigger behavior. To cope with complexity, perception does not treat all regions of the visual world equally, but focuses attention and sensory processing on those parts of the world that are important to the task at hand, such as determining whether a certain material is a biomass suitable for ingestion. Attention masks out (or assigns to the background) those parts of the sensory input that are irrelevant to task goals, or those aspects of sensory input that are predictable and therefore not noteworthy.

Portions of the visual field, as viewed by the sensors 2, that belong together are grouped into entities by the autonomous control system 5 and segmented from the rest of the image. At the lowest level in the image processing hierarchy, grouping consists of integrating all the energy imaged on each single pixel of the camera. At higher levels, pixels and entities are grouped according to gestalt heuristics such as proximity, similarity, contiguity, continuity, and symmetry. Grouping also establishes pointers from segmented regions in the image to entity frames that contain knowledge about the entity attributes, state, and relationships. Attributes and the state of each entity must be computed and stored in an entity frame. Attributes may include size, shape, color, texture, and temperature. State includes position, orientation, and velocity. Recursive estimation on entity attributes filters noise and enables the perception system to confirm or deny the gestalt hypothesis that created (defined) the entity. Recursive estimation uses entity state and state-prediction algorithms to track entities from one image to the next. When predictions correlate with observations, confidence in the gestalt hypothesis is strengthened. When variance occurs between predictions and observations, confidence in the gestalt hypothesis is reduced. When confidence rises above a credibility threshold, the gestalt hypothesis that established the entity is confirmed. For example, a hypothesis is that an entity is a tree. However, the state prediction algorithm (i.e., which predicts that a tree does not change its position on the ground) differs from the observation that the entity is actually moving; the observed variance causes the hypothesis to change (i.e., the entity is something other than a tree).

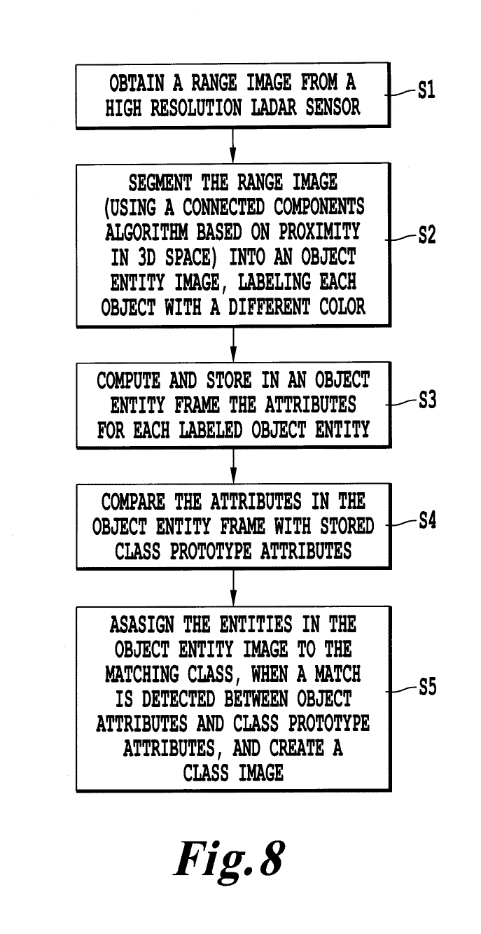

Attributes of each confirmed entity are compared with attributes of class prototypes (such as trees or rocks). When a match occurs, the entity is assigned to the class. Once an entity has been classified, it inherits attributes of the class. There is a hierarchy of classes to which an entity may belong. For example, an entity may be classified as a geometrical object, as a tree, as an evergreen tree, as a spruce tree, and as a particular spruce tree. More computing resources are required to achieve more specific classifications. Thus, an intelligent system, such as the autonomous control system 5, typically performs only the least specific classification required to achieve the task. An exemplary classification algorithm for entities, to be performed at each echelon of the sensory processing hierarchy, is shown in FIG. 8.

As seen in FIG. 8, in step S1 the EATR obtains a range image from a high resolution ladar sensor. After the range image is obtained, step S2 is to segment the range image (using a connected components algorithm based on proximity in 3D space) into an object entity image, labeling each object with a different color. In step S3, the EATR computes and stores in an object entity frame the attributes for each labeled object entity. Next, in step S4, the EATR compares the attributes in the object entity frame with stored class prototype attributes. Finally, in step S5, the EATR assigns the entities in the object entity image to the matching class, when a match is detected between object attributes and class prototype attributes, and creates a class image (for example, only height, width, and color attributes might be needed to classify an object as a tree).

As shown in FIG. 1, the EATR includes manipulators 3 that comprise one or more of a robotic arm, an end effector, and tools. The robotic arm, end effector, and tools can be used: (1) to gather, grasp, and manipulate sources of combustible energy, such as vegetation; (2) to manipulate objects to accomplish the mission or function of the robot. The robotic arm and end effector are of any suitable design. The tools may be grasped by the end effector, such as a cutting tool, or attached to the robotic arm as an integrated, modular end effector. The tools are used in energy gathering and manipulation, or for accomplishing the robot's mission or function.

The manipulators 3 are directly or indirectly attached to the platform 1. The manipulators 3 include any robotic arm and/or an end effector that have sufficient degrees-of-freedom, extend sufficiently from the platform 1, and have a sufficient payload to reach and lift appropriate material in the vicinity of the EATR.

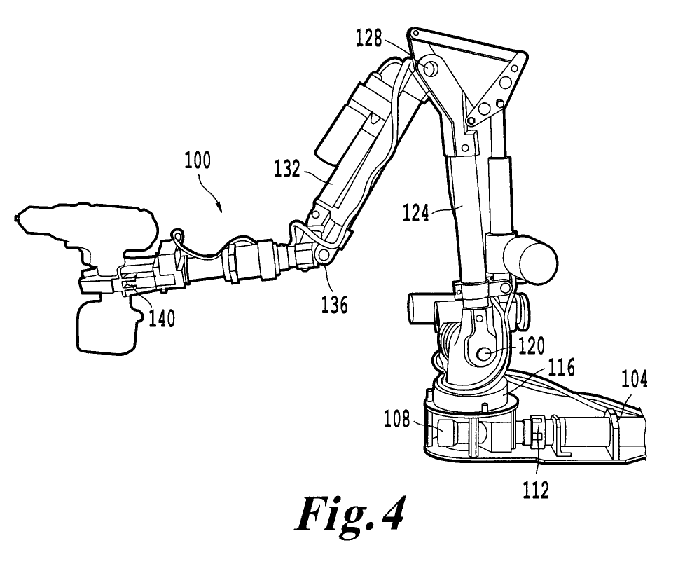

FIG. 4 shows an exemplary robotic arm 100. The robotic arm 100 is attached to the platform 1, directly or indirectly, via an attachment 104. The robotic arm 100 is supported by a support unit 108 and has a lift unit 112 to provide the power to lift a payload. Further, the robotic arm 100 has a column or base 116 and a shoulder 120 that attaches an upper arm 124 to the column or base 116. An elbow 128 connects the upper arm 124 to a lower arm 132 at a first end. The lower arm 132 has a wrist 136 at a second end. An end effector 200, such as a gripper 140, extends from the exemplary robotic arm 100 and performs various functions including grasping a tool, lifting a payload, or picking up biomass.

The end effector 200 may consist of a gripper 140, shown in FIG. 4, at an end of the robotic arm 100, or a multi-fingered hand, or a special-purpose tool. When the end effector 200 is a multi-fingered hand, the hand is attached to the robotic arm 100 via a spherical joint. The multi-fingered hand includes a palm and a plurality of phalanges (fingers and/or thumbs) that have joints (modified spherical, revolute) that give the hand sufficient degrees-of-freedom to grasp and operate a cutting tool (for example, a circular saw) to demonstrate an ability to prepare biomass for ingestion, and to grasp and manipulate the biomass for ingestion.

In an exemplary embodiment, the robotic arm 100 might extend 12 feet and lift as much as 200 lbs. The sensors 2 include an ultrasonic range sensor that is employed, as needed, to provide range information to the end effector 200 when it is close to the object (e.g., biomass) to be gripped. The end effector 200 might grip a conventional cutting tool (e.g., a circular saw) to cut tree limbs and branches. In another exemplary embodiment, the end effector is integrated with a cutting tool, such as a circular saw, such that the robotic hand grips a branch and cuts it simultaneously.

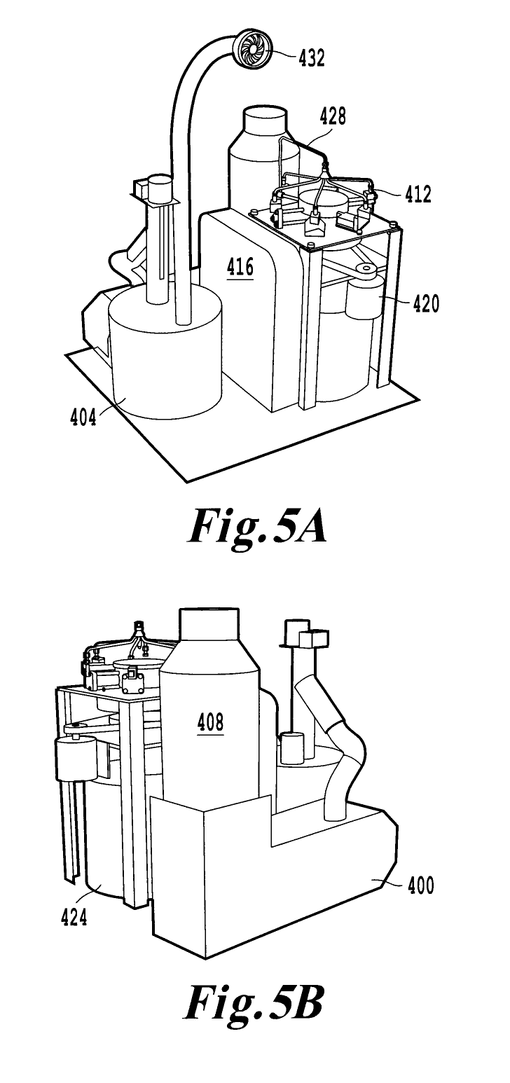

The engine subsystem 4 for the EATR includes a newly developed hybrid external combustion engine system from Cyclone Power Technology Inc. of 601 NE 26th Court, Pompano Beach, Fla. 33064. An example of such an engine is described in U.S. Pat. No. 7,080,512, which is herein incorporated by reference in its entirety. The engine system is integrated with a biomass combustion chamber to provide heat energy for the Rankine cycle steam engine, as shown in FIG. 5.

The engine subsystem 4 shown in FIG. 5 is a biomass generator system comprised of seven sections, each of which works in conjunction with the other six.

A burner system 400 of the engine subsystem 4 is a modified pellet burner from Pellx in Sweden. The burner system 400 was originally designed to burn wood pellets, which are manufactured from sawdust and other wood byproducts. The standard pellet is about ¼″ in diameter, and ½″ long. The unit is rated at 35 KW of heat energy. The burner system 400 is modified to accommodate larger pieces of wood. Wood, or other suitable biomass, is passed through a biomass cutter 432 to cut the biomass to an appropriate size and then sent to a biomass hopper 404. The burner system 400 is fed by a worm, which transports a measured quantity of wood from the hopper 404, which sits adjacent to the burner system 400. The quantity of fuel in the burner system 400 depends on the speed of the worm, which is called the ‘feeder’, and the speed of the blower. The combustion process in the burner system 400 is fuel plus air equals energy.

Heat from the burner system 400 makes steam by passing hot air around a set of stainless steel coils in a housing of the heat exchanger 408. The heat exchanger 408 is loaded with water from a water storage tank 424 by a 24v DC pump and an engine driven high-pressure pump. The 24v pump primes the engine driven pump, and supplies lubrication water for the engine 412. After the engine 412 begins to rotate after start-up, a constant supply of Ion-free water is forced through the hot coils and turned to steam and delivered to the engine 412 via a steam line 428. In normal operation, the steam temperature will be about 600 degrees F., and pressure at 200 p.s.i. or more.

After the steam has done its work of driving the engine 412, it is turned back into water by a condenser system 416. Much of the condensing is done in the crankcase of the engine 412, where cooling/lubricating Ion-free water is introduced to cool the steam coming through the pistons after the power stroke. The water then drains into the pan below the engine 412, which further cools it by the cooling fins on the perimeter. A centrifugal impeller pump in the pan forces the water into radiator/condenser 416. The radiator/condenser 416 is cooled by a pair of 24v DC fans, which further cool the water to slightly above ambient temperature. The air from the fans is quite warm, and might be used to dry the forage fuel. After the radiator/condenser 416, the water is sent to a reservoir below the engine 412. The reservoir is divided 75/25% by a full diameter one micron filter which traps foreign objects out of the water system.

Fuel is stored in the hopper 404 for combustion purposes. The hopper 404 contains an automatic Halon fire system, which can flood the hopper 404 with a non-combustible gas to prevent a hopper fire from spreading.

Nominal power for the unit is 24v DC. An alternator 420, driven by the engine 412, is capable of 4.9 kW, or about 175 amps at 24v. The engine subsystem 4 requires little electric energy to operate. The expected vehicle electric loads may be connected directly to the alternator 420. Power for the burner system 400 is supplied by a 750 w inverter, which changes the 24v supply into 230v AC. Care must be taken when working around the AC power, as a shock could be fatal. The 24v system is fused with an 80 amp fuse in the electric locker. Basic power is supplied by a pair of U1 12v batteries in series, which are mounted in the bottom of the electric locker.

The engine 412 is a low temperature, low pressure, external combustion Rankine cycle engine having 6 cylinders radially positioned. Thus, the engine 412 is light weight and has a long life. Further, the engine 412 is vertically oriented, steam driven, water lubricated, and self contained. It requires no oil for lubrication. Engine rpm and power are directly controlled by a combination of inlet temperature and pressure versus load. It will begin to rotate at pressures as low as 100 psi.

A 24 volt 175 ampere alternator 420 is the power source for the unit. It is centrifugally excited, internally regulated, and weather resistant. Note that the capacity of the alternator 420 is many times that of the batteries, and is intended to service the vehicle battery banks.

The EATR can also carry in a storage area additional conventional or unconventional sources of energy to supplement biomass, if necessary because of adverse environmental or mission conditions. The external combustion engine provides electric current, for example, for a rechargeable battery pack which powers the sensors 2, the autonomous control system 5, and the manipulators 3 (the battery ensures continuous energy output despite intermittent biomass energy intake). The hybrid external combustion engine is very quiet, reliable, efficient, and fuel-flexible compared with an internal combustion engine.

Unlike internal combustion engines, the Cyclone engine uses an external combustion chamber to heat a separate working fluid (de-ionized water) which expands to create mechanical energy by moving pistons or a turbine (i.e., Rankine cycle steam engine). Combustion is external so the engine runs on any fuel (solid, liquid, or gaseous), including biomass, agricultural waste, coal, municipal trash, kerosene, ethanol, diesel, gasoline, heavy fuel, chicken fat, palm oil, cottonseed oil, algae oil, hydrogen, propane, etc.—individually or in combination.

The Cyclone engine is environmentally friendly because combustion is continuous and more easily regulated for temperature, oxidizers, and fuel amount. Lower combustion temperatures and pressures create less toxic and exotic exhaust gases. A uniquely configured combustion chamber creates a rotating flow that facilitates complete air and fuel mixing, and complete combustion, so there are virtually no emissions. Less heat is released (hundreds of degrees lower than internal combustion exhaust), and it does not need a catalytic converter, radiator, transmission, oil pump, or lubricating oil (the Cyclone engine is water lubricated).

In an exemplary embodiment of the engine subsystem 4 for the EATR, where 1 kW recharges batteries for 1 hour (1 kWh), about 3-12 lbs of dry vegetation (wood or plants) produces 1 kWh. This power translates to 2-8 miles of driving by the platform 1 or more than 80 hours of standby, or 6-75 hours of mission operations (depending on power draw and duty cycle) before the EATR needs to forage, process, and generate/store power again. About 150 lbs of vegetation could provide sufficient energy for 100 miles of driving.

While the EATR is described above as using an exemplary steam engine as the external combustion engine, in alternative embodiments, the EATR could use a Stirling engine (coupled with a biomass combustion chamber) or another suitable engine.

Intelligent control with the autonomous control system 5 can be accomplished by any suitable architecture and associated software. The architecture and associated software can be incorporated in and executed by any suitable hardware, including, but not limited, to a personal computer, a processor, or other apparatus. Further, the architecture and associated software can be stored on a computer readable medium, such as a magnetic or optical disk or a storage unit in the personal computer.

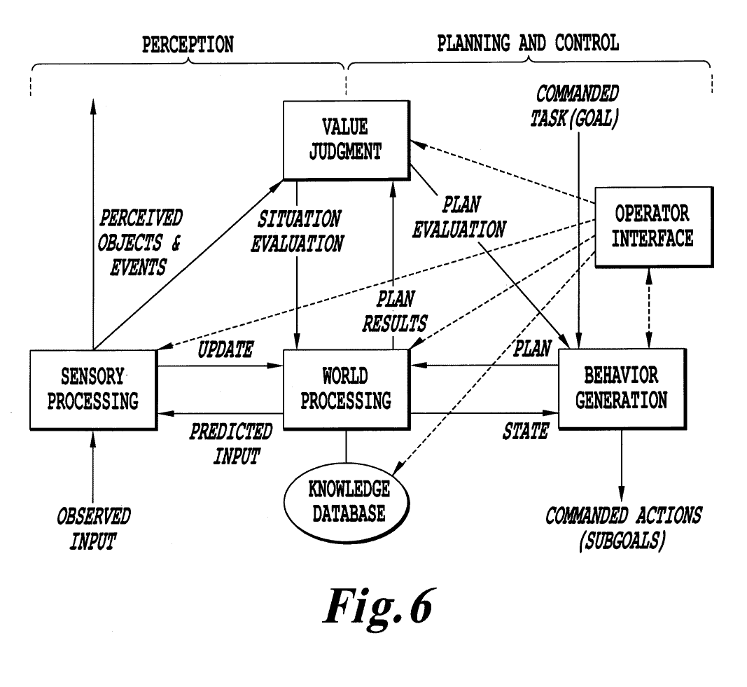

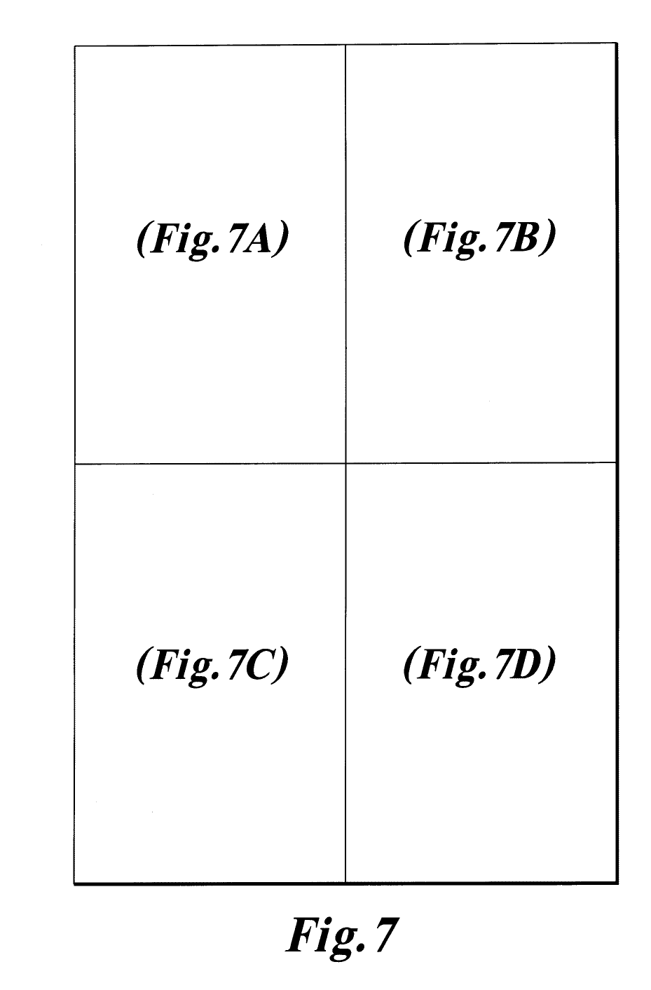

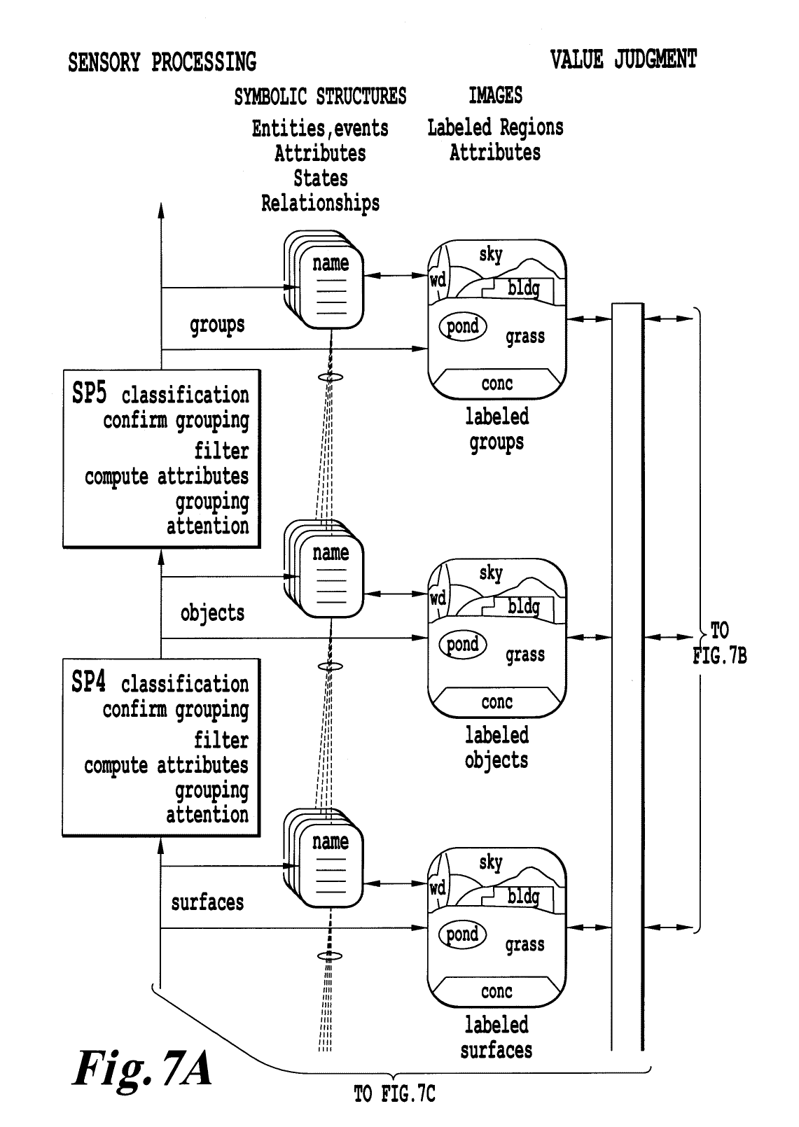

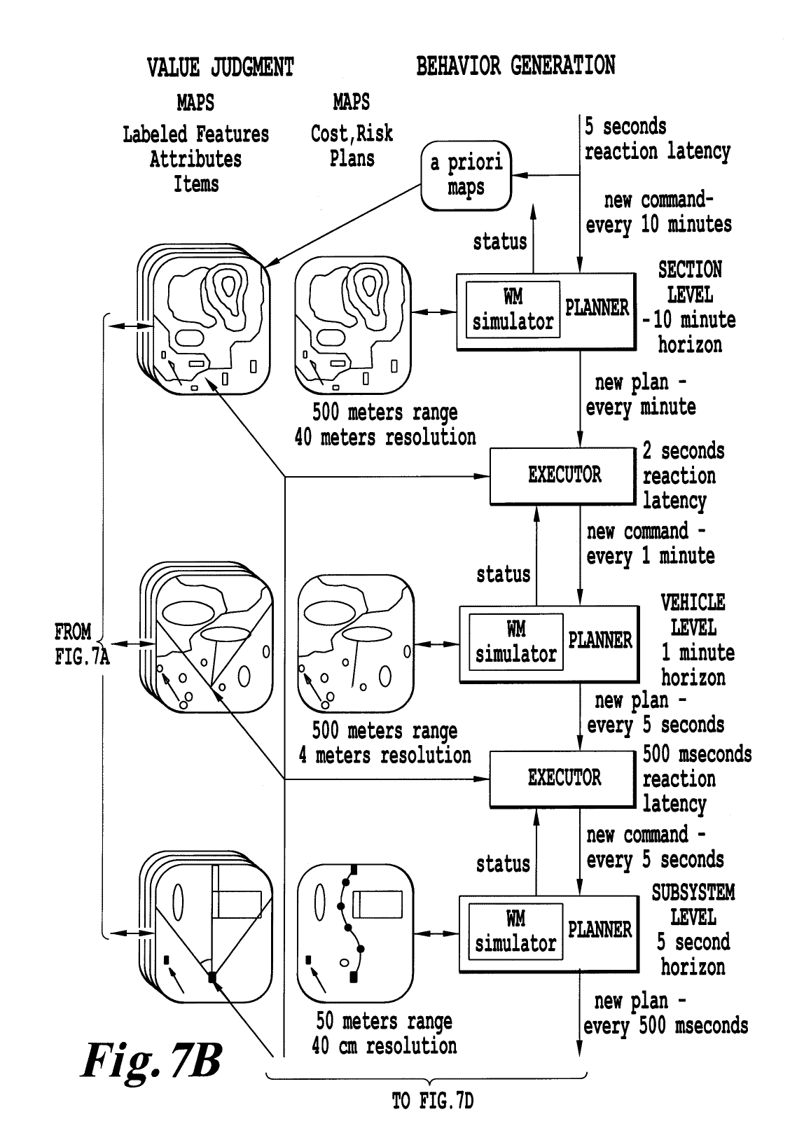

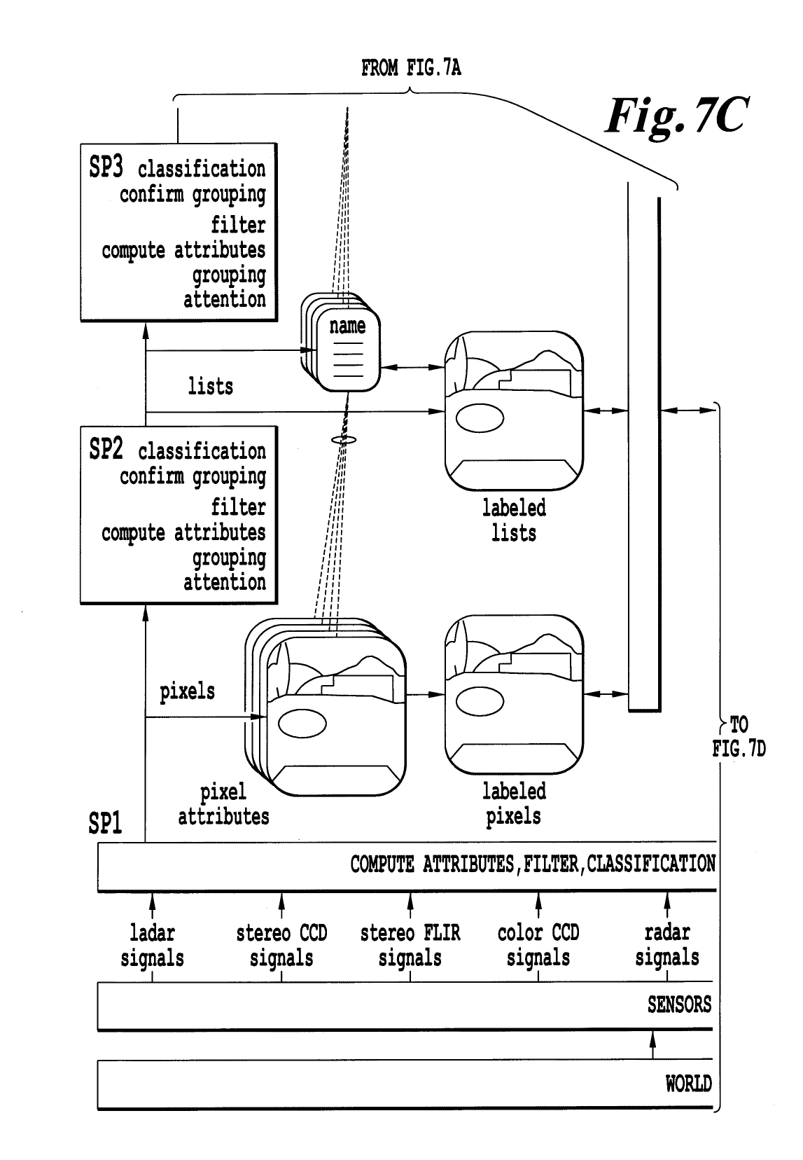

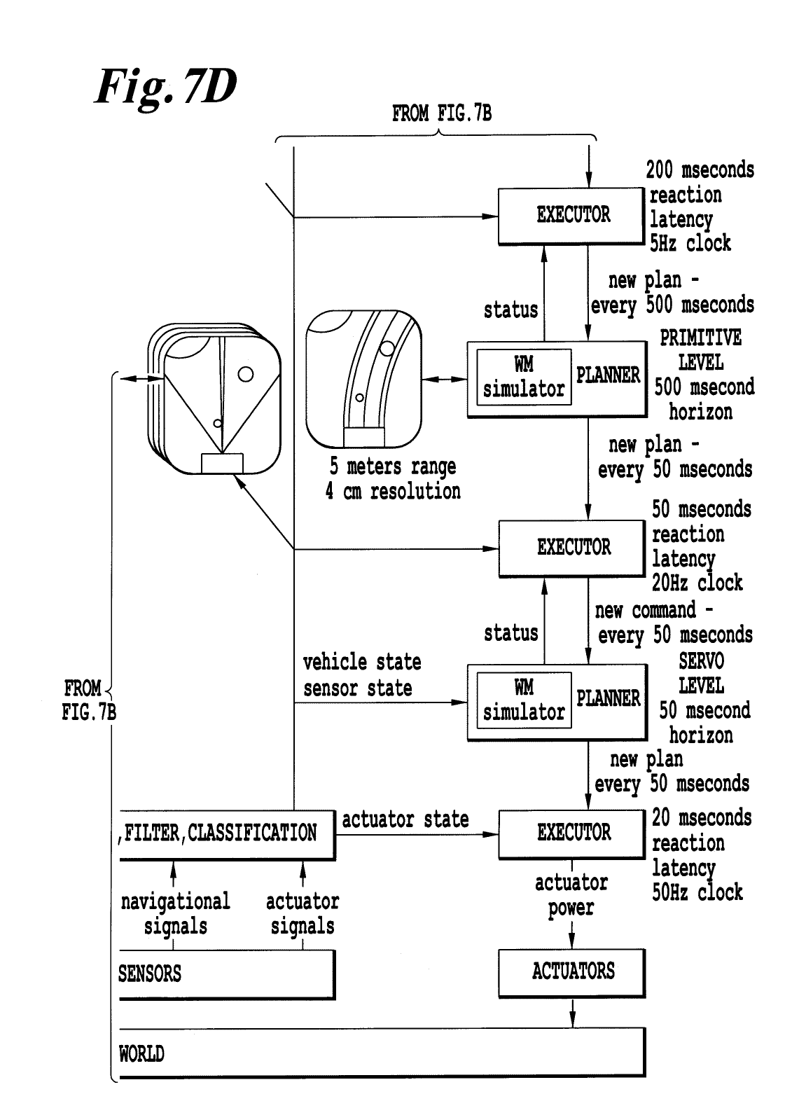

In one exemplary embodiment, the EATR uses a version of the 4D/RCS (1-Dimension of time and 3-Dimensions of space, Real-time Control System) developed by the National Institute of Standards and Technology (NIST), an agency of the U.S. Department of Commerce, the entirety of which is herein incorporated by reference, as the autonomous control system 5. A generic 4D/RCS node is illustrated in FIG. 6 and an example of the 4D/RCS hierarchy is illustrated in FIG. 7. The 4D/RCS used by EATR is sufficiently modified, including new software modules, that it has become proprietary to Robotic Technology Inc. (RTI) and is known at RTI as SAMI (System for Autonomous Machine Intelligence). The 4D/RCS was modified to become SAMI by adding software modules for processing the sensor data of the EATR-specific sensors and being able to distinguish vegetation sources of energy from materials that are not sources of energy (e.g., rocks, metal, plastic, etc.) and adding software modules to process ladar data to determine the 3-dimensional position of sources of energy and control the robotic arm and end effector to move to the sources of energy, grasp and manipulate the material, and move it to the hybrid engine system. In addition, other modifications and additions to the software increase the effectiveness and efficiency of the EATR's mobility and situational awareness.

SAMI provides the EATR with the ability (in conjunction with the sensors 2) to perceive the environment and suitable sources of energy, as well as perform its missions or functions, including the ability for autonomous or supervised autonomous guidance and navigation, situational awareness, and decision-making. Thus, SAMI is able to identify, locate, and acquire fuel for the EATR without commands from a handler outside of the EATR.

SAMI controls the movement and operation of the sensors 2; processes sensor data to provide situational awareness such that the EATR is able to identify and locate suitable biomass for energy production and otherwise perform its missions and functions; controls the movement and operation of the manipulators 3, including the robotic arm and end effector, to manipulate the biomass and ingest it into the combustion chamber of the engine subsystem 4; and controls the operation of the hybrid external combustion engine of the engine subsystem 4 to provide suitable power for the required functions. In identifying the suitable biomass, SAMI is also able to distinguish the suitable biomass from unsuitable material (for example, wood, grass, or paper from rocks, metal, or glass). SAMI is a framework in which the sensors 2, sensor processing, databases, computer models, and machine controls may be linked and operated such that the system behaves as if it were intelligent. SAMI provides a system with functional intelligence (where intelligence is the ability to make an appropriate choice or decision). It is a domain-independent approach to goal-directed, sensory-interactive, adaptable behavior, integrating high-level cognitive reasoning with low-level perception and feedback control in a modular, well-structured, and theoretically grounded methodology. It can be used to achieve full or supervised intelligent autonomy of individual platforms 1, as well as an overarching framework for control of systems of systems (e.g., incorporating unmanned and manned air, ground, sea surface, and undersea platforms, as well as serving as a decision tool for system of systems human controllers).

The intelligence provided by SAMI includes reactive intelligence, deliberative intelligence, and creative intelligence. The reactive intelligence is based on an autonomic sense-act modality which is the ability of the system to make an appropriate choice in response to an immediate environmental stimulus (i.e. a threat or opportunity). For example, the vehicle moves toward a vegetation sensed by optical image processing.

Deliberative intelligence, which includes prediction and learning, is based on world models, memory, planning and task decomposition, and includes the ability to make appropriate choices for events that have not yet occurred but which are based on prior events. For example, the vehicle moves downhill in a dry area to search for wetter terrain which would increase the probability of finding biomass for energy.

Creative intelligence, which is based on learning and the ability to cognitive model and simulate, is the ability to make appropriate choices about events which have not yet been experienced. For example, from a chance encounter with a dumpster, the vehicle learns that such entities are repositories of paper, cardboard, and other combustible materials, and develops tactics to exploit them as energy-rich sources of fuel.

The SAMI architecture is particularly well suited to support adaptability and flexibility in an unstructured, dynamic, tactical environment. SAMI has situational awareness, and it can perform as a deliberative or reactive control system, depending on the situation. SAMI is modular and hierarchically structured with multiple sensory feedback loops closed at every level. This permits rapid response to changes in the environment within the context of high-level goals and objectives.

At the lowest (Servo) level, SAMI closes actuator feedback control loops within milliseconds. At successively higher levels, the SAMI architecture responds to more complex situations with both reactive behaviors and real-time re-planning. Specifically, at the second (Primitive) level, SAMI reacts to inertial accelerations and potentially catastrophic movements within hundredths of a second. At the third (Subsystem) level, it reacts within tenths of a second to perceived objects, obstacles, and threats in the environment. At the fourth (Vehicle) level, it reacts quickly and appropriately to perceived situations in its immediate environment, such as aiming and firing weapons, taking cover, or maneuvering to optimize visibility to a target. At the fifth (Section) level, it collaborates with other vehicles to maintain tactical formation or to conduct coordinated actions. At the sixth (System of Systems) level, it serves as an overarching intelligent control and decision system for (all or part of) a manifold of distributed unmanned and manned platforms, unattended sensors and weapons, and control centers.

At each level, SAMI combines perceived information from the sensors 2 with a priori knowledge in the context of operational orders, changing priorities, and rules of engagement provided by a human commander. At each level, plans are constantly recomputed and reevaluated at a range and resolution in space and time that is appropriate to the duties and responsibilities assigned to that level. At each level, reactive behaviors are integrated with real-time planning to enable sensor data to modify and revise plans in real-time so that behavior is appropriate to overall goals in a dynamic and uncertain environment. This enables reactive behavior that is both rapid and sophisticated. At the section level and above, SAMI supports collaboration between multiple heterogeneous manned and unmanned vehicles (including combinations of air, sea, and ground vehicles) in coordinated tactical behaviors. It also permits dynamic reconfiguration of the chain of command, so that vehicles can be reassigned and operational units can be reconfigured on the fly as required to respond to tactical situations.

The SAMI methodology maintains a layered partitioning of tasks with levels of abstraction, sensing, task responsibility, execution authority, and knowledge representation. Each layer encapsulates the problem domain at one level of abstraction so all aspects of the task at this one layer can be analyzed and understood. The SAMI architecture can be readily adapted to new tactical situations, and the modular nature of SAMI enables modules to incorporate new rules from an instructor or employ learning techniques.

Accordingly, the EATR can provide: a revolutionary increase in robotic vehicle endurance and range; ability for a robot to perform extended missions autonomously; ability for a robot to occupy territory and perform a variety of missions with sensors or weapons indefinitely; and ability for a robot to perform a variety of military missions, such as small-unit or combat support for the military, or a variety of civil applications, such as in agriculture, forestry, and law enforcement, without the need for fuel causing a logistics burden on the users.

Military missions for the EATR can include long-range, long-endurance missions, such as reconnaissance, surveillance, and target acquisition (RSTA) without the need for human intervention or conventional fuels for refueling. However, in addition to vegetation, the EATR can, when necessary, also use conventional sources of energy (such as heavy fuel, gasoline, kerosene, diesel, propane, and coal) or unconventional sources of energy (such as algae, solar, wind, and waves). The EATR is ideal for many other military missions without requiring labor or materiel logistics support for refueling. For example, the EATR, having a heavy-duty robotic arm and hybrid external combustion engine, could provide direct support to combat units by: carrying the unit's backpacks and other material (the mule function); provide RSTA, weapons support, casualty extraction, or transport; provide energy to recharge the unit's batteries or directly power command and control centers. The EATR could forage, like an actual mule, for its own energy while the user unit rested or remained in position.

Civil applications can include: various agricultural functions (e.g., clearing, plowing, planting, weeding, and harvesting) where the EATR could obtain energy from gleanings from the field; various forestry functions (e.g., clearing debris, undesirable vegetation, illegal crops, and fire-hazard growth; patrolling, reconnaissance, and surveillance) while obtaining energy from forest waste vegetation; homeland security and law enforcement (e.g., patrolling in remote areas for illegal aliens, crops, or activity while obtaining energy from environmental vegetation).

Further, it should be appreciated that the present disclosure is not limited to the exemplary embodiments shown and described above. Instead, various alternatives, modifications, variations and/or improvements, whether known or that are, or may be, presently unforeseen, may become apparent. Accordingly, the exemplary embodiments, as set forth above are intended to be illustrative, not limiting. The various changes may be made without departing from the spirit and scope of the disclosure. Therefore, the systems and methods according to the exemplary embodiments are intended to embrace all now known or later-developed alternatives, modifications, variations and/or improvements.

What is claimed is:

1: A robotic apparatus, comprising:
a platform to transport the robotic apparatus;
a power generator to convert fuel to energy to provide power for the platform;
manipulators to transfer the fuel from outside of the robotic apparatus to the power generator;
an autonomous control system to identify, locate, and acquire the fuel for the robotic apparatus by controlling the platform and the manipulators.

2: The robotic apparatus according to claim 1, further comprising:
a plurality of sensors to provide information to the autonomous control system to control the platform and the manipulators.

3: The robotic apparatus according to claim 1, wherein at least one of the sensors is a ladar sensor.

4: The robotic apparatus according to claim 1, wherein the manipulators include a robotic arm and an end effector positioned on an end of the robotic arm.

5: The robotic apparatus according to claim 4, wherein the end effector includes a plurality of phalanges to grasp the fuel.

6: The robotic apparatus according to claim 1, wherein the autonomous control system identifies, locates, and acquires the fuel without receiving commands from a handler outside of the robotic apparatus.

7: The robotic apparatus according to claim 1, wherein the autonomous control system receives instructions from a handler to override instructions generated by the autonomous control system.

8: The robotic apparatus according to claim 1, wherein the power generator includes an external combustion engine.

9: The robotic apparatus according to claim 8, wherein the power generator includes a biomass combustion chamber to provide heat energy for the external combustion engine.

10: The robotic apparatus according to claim 9, wherein the biomass combustion chamber burns the fuel, and the fuel includes an organic-based energy source, biomass, or petroleum based fuel.

11: The robotic apparatus according to claim 1, wherein the autonomous control system includes reactive intelligence based on an automatic sense-act modality.

12: The robotic apparatus according to claim 1, wherein the autonomous control system includes deliberative intelligence including prediction and learning to make appropriate choices to locate and identify the fuel based on prior events when the robotic apparatus attempted to locate and identify a suitable fuel.

13: The robotic apparatus according to claim 1, wherein the autonomous control system includes creative intelligence to automatically make appropriate choices to acquire and identify the fuel in an environment in which the robotic apparatus has not acquired or identified a suitable fuel before.

14: A method for a control system to autonomously supply power to a robotic apparatus, comprising:
identifying an energy source;
locating an approximate spatial location of the energy source;
moving the robotic apparatus to a vicinity of the energy source;
extending a robotic arm and an end effector of the robotic apparatus to contact the energy source;
grasping and manipulating the energy source with the end effector;
transporting the energy source with the end effector and the robotic arm to a power generator;
converting, at the power generator, the energy source to power for the robotic apparatus; and
powering the robotic apparatus with the power converted by the power generator.

15: The method according to claim 14, wherein the identifying, the locating, the moving, the extending, the grasping, and the transporting are controlled by the control system without receiving commands from a handler outside of the robotic apparatus.

16: The method according to claim 14, wherein the identifying and the locating includes verifying a candidate energy source is one of a plurality of suitable energy sources by analyzing a distribution of radiation frequencies radiated from the candidate energy source.

17: The method according to claim 14, further comprising:
analyzing the energy source to distinguish a suitable energy source from an unsuitable energy source.

18: The method according to claim 14, further comprising:
deciding to supply additional power for the robotic apparatus based on information about local data, and the deciding to supply additional power occurs prior to the identifying the energy source.
